(19) United States
(12) Patent Application Publication
(10) Pub. No.: US 2025/0310093 A1
(43) Pub. Date: Oct. 2, 2025

(54) BLIND SECRET MANAGEMENT AND ROTATION

(71) Applicant: CyberArk Software Ltd., Petach-Tikva (IL)

(72) Inventors: Erez Waisbard, Petach-Tikva (IL); Gil Adda, Petach-Tikva (IL)

(73) Assignee: CyberArk Software Ltd., Petach-Tikva (IL)

(21) Appl. No.: 18/622,983

(22) Filed: Mar. 31, 2024

(51) Int. Cl. H04L 9/08; H04L 9/00

(52) U.S. Cl. CPC H04L 9/0869; H04L 9/008; H04L 9/0825; H04L 9/0891; H04L 9/0894

(57) ABSTRACT

Disclosed embodiments relate to providing blind secret management and rotation. Techniques include identifying, by a secret rotation manager operating in a first network environment, an encrypted version of a first key material, generating, by the secret rotation manager, an additional key material, combining the encrypted first key material and the additional key material, and providing the combined key material to a rotation agent operating in a second network environment, wherein the rotation agent is configured to decrypt the encrypted first key material from the combined key material, and wherein the rotation agent is configured to generate, according to a secret generation policy, a secret using at least the combined key material.

### BACKGROUND

Modern secret management systems employ a variety of techniques to manage and rotate secrets. Secret rotation in current secret management systems may involve securely storing a secret, rotating the secret periodically, and applying the newly rotated secret on a customer's target network environment. One approach to secret rotation is to store the secrets encrypted at rest and to expose the secrets to a central management system only during rotation. Secret rotation may be implemented automatically to provide periodic rotation of secrets and to minimize the risk of human error in rotating the secrets. Automatic secret rotation may utilize systems that can automatically generate new secrets, distribute them to target network environments, and disable or decommission secrets as needed. Such an automatic secret rotation may occur at regular intervals or in response to a specific event. Rotating secrets periodically may minimize the opportunities for a hacker to attack a secure network environment with a comprised secret.

Although secret rotation may minimize the risk of an attack on a secure network environment with the use of a compromised secret, the process of storing and rotating the secret may expose the secret to attack. For example, the secret may be exposed at the secret management system during creation of the secret and rotation of the secret. The secret may also be exposed during rotation of the secret at the secret rotation manager as part of the secret management system. Because the secret management system has access to the clear secret for use during rotation, the clear secret may potentially be accessed by a privileged user of the secret management system. This may expose the clear secret to attack through a compromised privileged user account. Additionally, when the secret is rotated, the secret may need to be updated in both the secret management system and the target network environment or service. Therefore, the secret may be subject to attack in the secret management system. A breach to the secret management system may expose a variety of secrets to attack, and the risk grows over time as the number of managed secrets increases. Additionally, if the secret management system is implemented in a cloud computing environment, a breach of the cloud computing environment may further lead to the secret being compromised.

Therefore, to address these technical and security deficiencies in secret rotation, solutions should be implemented to store encrypted key materials in a secret management system. Such solutions should ensure that no clear secrets are stored outside of a dedicated network, such as the customer's network, at any time, which may minimize the attack surface of the secrets. For example, such solutions should provide a secret management system in that may store an encrypted first key material and generate additional key material based on the encrypted first key material without decrypting the encrypted first key material. Further, the key material for the secret should remain encrypted during transfer of the key material from the secret management system to the customer network environment. Such solutions should provide increased security by allowing the secret management system to generate a new key material in the customer's network environment, according to the customer's secret generation policy while remaining blind to the clear secret. These solutions may provide increased security of customer network environments by reducing the exposure of clear secrets during secret management and rotation and thus minimizing an attacker's ability to access a network environment through the use of a compromised secret.

### SUMMARY

The disclosed embodiments describe non-transitory computer readable media for providing blind secret management and rotation. For example, in an embodiment, a non-transitory computer readable medium may include instructions that, when executed by at least one processor, cause the at least one processor to perform operations for providing blind secret management and rotation. The operations may comprise identifying, by a secret rotation manager operating in a first network environment, an encrypted version of a first key material, generating, by the secret rotation manager, an additional key material, and providing the first key material and the additional key material to at least one rotation agent operating in a second network environment, wherein the at least one rotation agent is configured to decrypt the encrypted first key material, and wherein the at least one rotation agent is configured to generate, according to a secret generation policy, a secret using at least the first key material and the additional key material.

According to a disclosed embodiment, the operations may further comprise encrypting, by the secret rotation manager, the additional key material, combining the encrypted first key material and the encrypted additional key material, and providing the combined encrypted key material to the at least one rotation agent, wherein the at least one rotation agent is configured to decrypt the combined encrypted key material.

According to a disclosed embodiment, combining the encrypted first key material and the encrypted additional key material may be based on at least one of: concatenation or homomorphic encryption.

According to a disclosed embodiment, the rotation agent may be further configured to generate a public key and a private key, and to access the public key and the private key, and wherein the operations may further comprise receiving, by the secret rotation manager, the public key, and wherein encrypting the additional key material may comprise using the public key and decrypting the additional key material may comprise using the private key.

According to a disclosed embodiment, identifying the encrypted version of the first key material may comprise receiving, from a customer operating in the second network environment, the encrypted first key material.

According to a disclosed embodiment, identifying the encrypted version of the first key material may comprise generating the first key material, encrypting the first key material, and storing the encrypted first key material.

According to a disclosed embodiment, generating the additional key material may comprise generating a random value from the encrypted first key material, wherein the random value may be generated by at least one of: a random generator in the first network environment, the rotation agent, or a third-party random generator.

According to a disclosed embodiment, the decrypted first key material and the secret may be stored in at least one of a volatile memory or a protected memory region.

According to a disclosed embodiment, the operations may further comprise storing the decrypted first key material and the secret as cleartext configured for registration of the secret with a target service in the second network environment.

According to a disclosed embodiment, the secret generation policy may be provided to the at least one rotation agent by at least one of: the secret rotation manager, a storage location in the second network environment, or a third-party.

According to a disclosed embodiment, the operations may further comprise retrieving the secret generation policy from a first secure location in the first network environment or from a second secure location in the second network environment that is accessible to the at least one rotation agent.

According to a disclosed embodiment, the key material may be composed of a chain of values between the encrypted first key material and a plurality of additional key materials.

According to a disclosed embodiment, the operations may further comprise retrieving the plurality of additional key materials from a secret store.

According to a disclosed embodiment, the operations may further comprise compacting the encrypted first key material and the plurality of additional key materials.

The disclosed embodiments further describe a computer-implemented method for providing blind secret management and rotation. For example, in an embodiment, a computer-implemented method for providing blind secret management and rotation may include operations that may comprise identifying, by a secret rotation manager operating in a first network environment, an encrypted version of a first key material, generating, by the secret rotation manager, an additional key material, and providing the first key material and the additional key material to at least one rotation agent operating in a second network environment, wherein the at least one rotation agent is configured to decrypt the encrypted first key material, and wherein the at least one rotation agent is configured to generate, according to a secret generation policy, a secret using at least the first key material and the additional key material.

According to a disclosed embodiment, combining the encrypted first key material and the additional key material may be based on at least one of: concatenation or homomorphic encryption.

According to a disclosed embodiment, the homomorphic encryption may comprise an RSA public key encryption scheme or an ElGamal encryption scheme.

According to a disclosed embodiment, generating the additional key material may comprise using a true Random Number Generator.

According to a disclosed embodiment, the operations may further comprise encrypting the additional key material using a public key, combining the encrypted first key material and the encrypted second key material, and providing the combined encrypted key material to the at least one rotation agent, and wherein the at least one rotation agent is configured to decrypt the combined encrypted key material using a private key of the at least one rotation agent.

The disclosed embodiments further describe a computer-implemented method for providing a clear secret corresponding to an encrypted secret. For example, in an embodiment, a computer-implemented method for providing a clear secret associated with an encrypted secret may include operations that may comprise requesting, from an application associated with a network identity operating in a second network environment, the clear secret, wherein the request comprises a secret identifier and a public key of a key pair, retrieving, by a secret management service operating in a first network environment, the encrypted secret associated with the secret identifier, sending, by the secret management service to an agent, the encrypted secret and the public key, decrypting, by the agent, the encrypted secret using a cryptographic master key, encrypting, by the agent, the secret using the public key, returning the encrypted secret to the secret management service, transmitting the encrypted secret from the secret management service to the application, decrypting, by the application, the encrypted secret using a private key of the key pair, and providing, by the application, the clear secret to the network identity.

According to a disclosed embodiment, the operations may further comprise generating, by the application, the key pair.

According to a disclosed embodiment, the operations may further comprise storing the private key in a location accessible by the application.

According to a disclosed embodiment, the agent may be at least one of: the rotation agent or a local key store.

According to a disclosed embodiment, the agent may be located in one of: a computing device associated with the network identity, an on-premise computing device operating in the second network environment, or a cloud based environment.

According to a disclosed embodiment, the first network environment may comprise a cloud-based environment.

According to a disclosed embodiment, the secret management service may be blind to the clear secret.

According to a disclosed embodiment, the clear secret may be associated with an account.

According to a disclosed embodiment, the account may comprise a directory account enabling the network identity to access a computing resource.

According to a disclosed embodiment, the second network environment may comprise at least one of: a cloud-based environment or a self-hosted server.

Aspects of the disclosed embodiments may include tangible computer readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, explain the disclosed embodiments.

FIG. 1 is a block diagram of a system for providing blind secret management and rotation in accordance with disclosed embodiments.

FIG. 2 is a block diagram showing a computing device including a rotation agent for providing blind secret management and rotation in accordance with disclosed embodiments.

FIG. 3 is a block diagram showing a process for providing blind secret management and rotation in accordance with disclosed embodiments.

FIG. 4 is a flowchart showing a process for providing blind secret management and rotation by a secret rotation manager in accordance with disclosed embodiments.

FIG. 5 is a flowchart showing a process for providing blind secret management and rotation by a rotation agent in accordance with disclosed embodiments.

FIG. 6A is a block diagram showing a process for providing a clear secret corresponding to an encrypted secret in accordance with disclosed embodiments.

FIG. 6B is a block diagram showing a process for providing a clear secret corresponding to an encrypted secret in accordance with disclosed embodiments.

FIG. 7 is a flowchart showing a process for providing a clear secret corresponding to an encrypted secret in accordance with disclosed embodiments.

### DETAILED DESCRIPTION

In the following detailed description, numerous specific details are set forth to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

The techniques for providing blind secret management and rotation described herein overcome several technological problems relating to security, efficiency, and functionality in the fields of cybersecurity and software management. In particular, the disclosed embodiments provide techniques for managing and rotating a secret while a secret management system remains blind to the secret. As discussed above, attackers may access a customer's network environment through the use of secrets managed or rotated through a secret management system. Reducing the locations in which a clear secret is known or accessible may reduce opportunities for attackers to gain access to the clear secret, and thus the customer's network environment. Existing techniques for providing secret management and rotation, however, fail to provide a secret management system that is blind to the clear secret.

The disclosed embodiments provide technical solutions to these and other problems arising from current techniques. For example, various disclosed techniques create efficiencies over current techniques by providing a secret management system that can store a secret and generate new key material according to a customer's secret generation policy without knowledge of the clear secret. The disclosed techniques do not require that the secret management system know the clear secret to store and rotate the secret, thereby improving security in the network. The disclosed techniques do not transfer a clear secret from the secret management system to the rotation agent in the customer's network environment, further improving security in the network. The disclosed techniques further provide a secret management system that cannot decrypt the encrypted secret, thus preventing a compromised privileged account from decrypting and accessing clear secrets from the secret management system.

Reference will now be made in detail to the disclosed embodiments, examples of which are illustrated in the accompanying drawings.

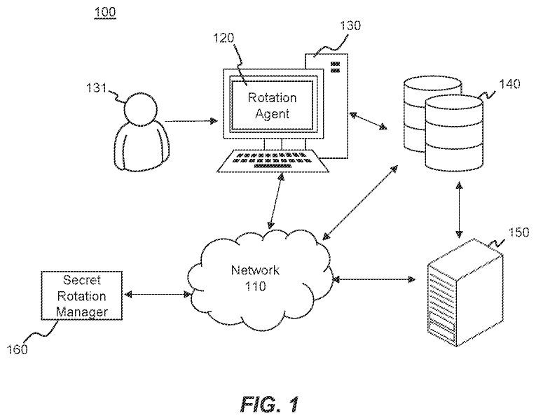

FIG. 1 illustrates an exemplary system 100 for providing blind secret management and rotation, consistent with the disclosed embodiments. System 100 may represent an environment in which software code is developed and/or executed, for example in a cloud computing environment. System 100 may include one or more rotation agent 120, one or more computing devices 130, one or more databases 140, one or more servers 150, and one or more secret rotation managers 160, as shown in FIG. 1.

The various components may communicate over a network 110. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system 100 is shown as a network-based environment, it is understood that the disclosed systems and methods may also be used in a localized system, with one or more of the components communicating directly with each other.

Computing devices 130 may be a variety of different types of computing devices capable of developing, storing, analyzing, and/or executing software code. For example, computing device 130 may be a personal computer (e.g., a desktop or laptop), an IoT device (e.g., sensor, smart home appliance, connected vehicle, etc.), a server, a mainframe, a vehicle-based or aircraft-based computer, a virtual machine (e.g., virtualized computer, container instance, etc.), or the like. Computing device 130 may be a handheld device (e.g., a mobile phone, a tablet, or a notebook), a wearable device (e.g., a smart watch, smart jewelry, an implantable device, a fitness tracker, smart clothing, a head-mounted display, etc.), an IoT device (e.g., smart home devices, industrial devices, etc.), or various other devices capable of processing and/or receiving data. Computing device 130 may operate using a Windows™ operating system, a terminal-based (e.g., Unix or Linux) operating system, a cloud-based operating system (e.g., through AWS™, Azure™, IBM Cloud™, etc.), or other types of non-terminal operating systems.

System 100 may further comprise one or more database(s) 140, for storing and/or executing software. For example, database 140 may be configured to store software or code, such as code developed using computing device 130. Database 140 may further be accessed by computing device 130, server 150, or other components of system 100 for downloading, receiving, processing, editing, or running the stored software or code. Database 140 may be any suitable combination of data storage devices, which may optionally include any type or combination of databases, load balancers, dummy servers, firewalls, back-up databases, and/or any other desired database components. In some embodiments, database 140 may be employed as a cloud service, such as a Software as a Service (SaaS) system, a Platform as a Service (PaaS), or Infrastructure as a Service (IaaS) system. For example, database 140 may be based on infrastructure or services of Amazon Web Services™ (AWS™), Microsoft Azure™, Google Cloud Platform™, Cisco Metapod™, Joyent™, vmWare™, or other cloud computing providers. Data sharing platform 140 may include other commercial file sharing services, such as Dropbox™, Google Docs™, or iCloud™. In some embodiments, data sharing platform 140 may be a remote storage location, such as a network drive or server in communication with network 110. In other embodiments database 140 may also be a local storage device, such as local memory of one or more computing devices (e.g., computing device 130) in a distributed computing environment.

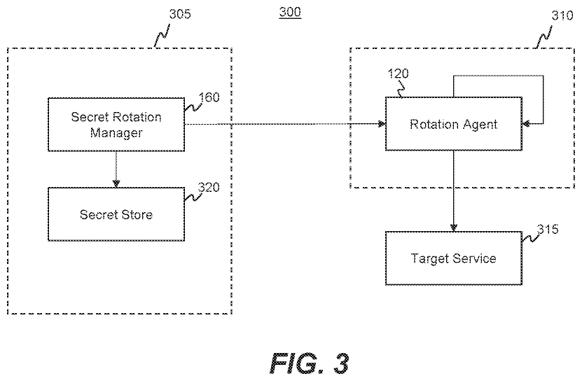

System 100 may also comprise one or more server device(s) 150 in communication with network 110. Server device 150 may manage the various components in system 100. In some embodiments, server device 150 may be configured to process and manage requests between computing devices 130 and/or databases 140. In embodiments where software code is developed within system 100, server device 150 may manage various stages of the development process, for example, by managing communications between computing devices 130 and databases 140 over network 110. Server device 150 may identify updates to code in database 140, may receive updates when new or revised code is entered in database 140, and may participate in providing blind secret management and rotation as discussed below in connection with FIGS. 3-5.

System 100 may also comprise one or more rotation agents 120 in communication with network 110. Rotation agent 120 may be any device, component, program, script, or the like, for providing blind secret management and rotation within system 100, as described in more detail below. Rotation agent 120 may be configured to monitor other components within system 100, including computing device 130, database 140, and server 150. In some embodiments, rotation agent 120 may be implemented as a separate component within system 100, capable of analyzing software and computer codes or scripts within network 110. In other embodiments, rotation agent 120 may be a program or script and may be executed by another component of system 100 (e.g., integrated into computing device 130, database 140, or server 150). Rotation agent 120 may further comprise one or more components for performing various operations of the disclosed embodiments. For example, rotation agent 120 may be configured to receive combined key material from a secret rotation manager, decrypt the encrypted first key material from the combined key material, and generate a secret according to a secret generation policy using the combined key material as discussed below.

System 100 may further comprise a secret rotation manager 160. Secret rotation manager 160 may be any device, component, program, script, or the like, for providing secret rotation management within system 100, and may include any form of secure storage location for storing encrypted secrets and key materials, which may include, but are not limited to, passwords, usernames, credentials, Application Programming Interface (API) keys, encryption keys, hash values, identity and access management (IAM) permissions, Secure Shell Protocol (SSH) keys, tokens, certificates, biometric data, or any other form of access credential for use in managing access to applications, services, privileged accounts, and other secure network resources. Secret rotation manager 160 may allow for central management of encrypted secrets across multiple accounts within a network. In particular, secret rotation manager 160 may identify encrypted versions of a first key material, generate additional key material, combine the encrypted first key material and the additional key material, and provide the combined key material to rotation agent 120.

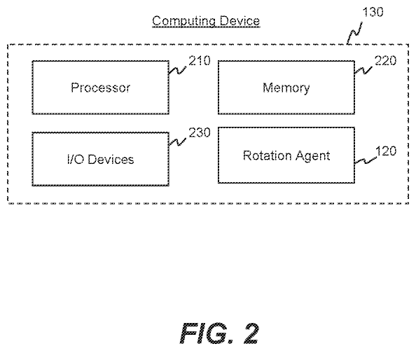

FIG. 2 is a block diagram showing a computing device 130 including rotation agent 120 in accordance with disclosed embodiments. Computing device 130 may include a processor 210. Processor (or processors) 210 may include one or more data or software processing devices. For example, the processor 210 may take the form of, but is not limited to, a microprocessor, embedded processor, or the like, or may be integrated in a system on a chip (SoC). Furthermore, according to some embodiments, the processor 210 may be from the family of processors manufactured by Intel®, AMD®, Qualcomm®, Apple®, NVIDIA®, or the like. The processor 210 may also be based on the ARM architecture, a mobile processor, or a graphics processing unit, etc. In some embodiments, rotation agent 120 may be employed as a cloud service, such as a Software as a Service (SaaS) system, a Platform as a Service (PaaS), or Infrastructure as a Service (IaaS) system. For example, rotation agent 120 may be based on infrastructure of services of Amazon Web Services™ (AWS™), Microsoft Azure™, Google Cloud Platform™, Cisco Metapod™, Joyent™, vmWare™, or other cloud computing providers. The disclosed embodiments are not limited to any type of processor configured in the computing device 130.

Memory (or memories) 220 may include one or more storage devices configured to store instructions or data used by the processor 210 to perform functions related to the disclosed embodiments. Memory 220 may be configured to store software instructions, such as programs, that perform one or more operations when executed by the processor 210 to provide blind secret management and rotation from computing device 130, for example, using process 400, described in detail below. The disclosed embodiments are not limited to software programs or devices configured to perform dedicated tasks. For example, the memory 220 may store a single program, such as a user-level application, that performs the functions of the disclosed embodiments, or may comprise multiple software programs. Additionally, the processor 210 may in some embodiments execute one or more programs (or portions thereof) remotely located from the computing device 130. Furthermore, the memory 220 may include one or more storage devices configured to store data (e.g., machine learning data, training data, algorithms, etc.) for use by the programs, as discussed further below.

Computing device 130 may further include one or more input/output (I/O) devices 230. I/O devices 230 may include one or more network adaptors or communication devices and/or interfaces (e.g., WiFi, Bluetooth®, RFID, NFC, RF, infrared, Ethernet, etc.) to communicate with other machines and devices, such as with other components of system 100 through network 110. For example, rotation agent 120 may use a network adaptor to scan for code and code segments within system 100. In some embodiments, the I/O devices 230 may also comprise a touchscreen configured to allow a user to interact with rotation agent 120 and/or an associated computing device. The I/O device 230 may comprise a keyboard, mouse, trackball, touch pad, stylus, and the like.

Aspects of the present disclosure may involve providing blind secret management and rotation. Blind secret management and rotation may refer to storing and rotating a secret without knowledge of the clear secret. For example, secret rotation manager 160 may operate in a first network environment and store encrypted key material, generate new key material, combine the encrypted key material and new key material, and provide the combined key material to rotation agent 120 operating in a second network environment. Secret rotation manager 160 may have no knowledge of the clear secret because the key material may be encrypted when stored and accessed by the secret rotation manager 160. Rotation agent 120 may receive the combined key material and be configured to decrypt the encrypted first key material and generate, according to a secret generation policy, a secret using the combined key material. Therefore, the encrypted key material may potentially only be decrypted by rotation agent 120 operating in the second network environment.

FIG. 3 is a block diagram illustrating a blind secret management system 300, including secret rotation manager 160 and secret store 320 operating in first network environment 305, and rotation agent 120 operating in second network environment 310. Rotation agent 120 may be in communication with a target service 315 operating within or outside of second network environment 310. As depicted in FIG. 3, secret rotation manager 160 and secret store 320 may operate in a first network environment 305. First network environment 305 may comprise an on-premises computing environment or a cloud computing environment, such as a Software as a Service (SaaS) system, a Platform as a Service (PaaS), or Infrastructure as a Service (IaaS) system. For example, first network environment 305 may be based on infrastructure or services of Amazon Web Services™ (AWS™), Microsoft Azure™, Google Cloud Platform™, Cisco Metapod™, Joyent™, vmWare™, or other cloud computing providers. Secret store 320 may be any form of secure storage location for storing secrets, which may include, but are not limited to, passwords, usernames, credentials, Application Programming Interface (API) keys, encryption keys, hash values, identity and access management (IAM) permissions, SSH keys, tokens, certificates, biometric data, or any other form of access credential for use in managing access to applications, services, privileged accounts, and other secure network resources. Secret store 320 may authenticate and authorize users, identities, machines, or applications attempting to access one or more secrets before permitting access to stored sensitive data. As an example implementation, secret store 320 may be implemented as a CyberArk™ vault or the like. Alternative implementations of secret store 320 are possible as well. Secret rotation manager 160 may retrieve encrypted secrets or key materials from secret store 320. For example, secret rotation manager 160 may send a request to secret store 320 to retrieve a secret or key material. In response, secret store 320 may retrieve the encrypted secret or key material and return the encrypted secret or key material to secret rotation manager 160 over a secured channel. Secret rotation manager 160 may provide the encrypted key material to rotation agent 120 operating in second network environment 310.

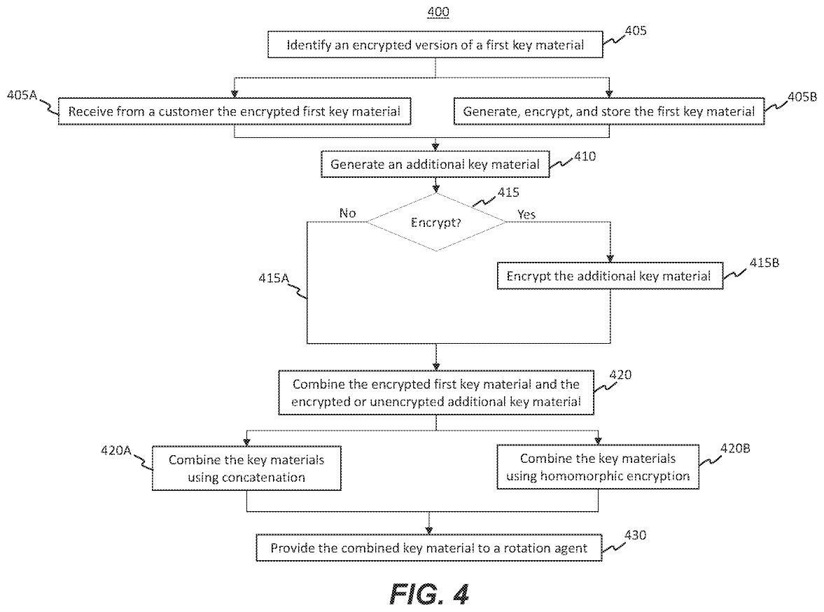

As depicted in FIG. 3, rotation agent 120 may operate in second network environment 310. In some embodiments, as depicted in FIG. 3, rotation agent 120 may be in communication with a target service 315 operating outside of second network environment 310. In other embodiments, target service 315 may be operating within second network environment 310. As depicted in FIG. 3, second network environment 310 may comprise one rotation agent 120. In other embodiments, second network environment 310 may comprise more than one rotation agent 120. Providing more than one rotation agent 120 in second network environment 310 may provide backup to avoid the loss of key material. Providing more than one rotation agent 120 may also provide a more secure secret rotation by splitting the role of secret rotation between more than one rotation agent 120. Second network environment 310 may be distinct from first network environment 305 and may be operated by a customer, such as user 131, or an enterprise, office, school, government, etc. Second network environment 310 may comprise an on-premises computing environment or a cloud computing environment. The customer, such as user 131, may have access to both the first network environment 305 and second network environment 310. However, a system operator of the first network environment 305 may not have access to the second network environment 310, and thus the system operator may not have access to clear secrets stored in second network environment 310. Target service 315 may refer to any type of computing resource within a network that may be accessed by entities (e.g., users, machines, applications) using a secret through a communications network. Examples of target service 315 may include servers, databases or data structures holding confidential information, restricted-use applications, operating system directory services, access-restricted cloud-computing resources, sensitive IoT equipment, or any other computer-based equipment or software that may be accessible over a network (e.g., network 110). Other examples of target service 315 may include files, folders, elements in cloud buckets, databases, serverless function settings, logs, computer programs, computer codes, machine executable instructions, or any other type of data that may be stored in a data structure. Target service 315 may be accessible through use of a secret that is subject to secret management and rotation through process 400, as disclosed herein with respect to FIG. 4. Rotation agent 120 may receive a combined key material from secret rotation manager 160, decrypt the encrypted key material in the combined key material, and generate a secret based on the combined key material. Rotation agent 120 may then apply the generated secret to target service 315.

FIG. 4 is a flowchart depicting process 400 for providing blind secret management and rotation by a secret rotation manager 160, consistent with the disclosed embodiments. Process 400 may commence continuously, periodically, upon a trigger event, or manually. Examples of periodic commencement may be hourly, weekly, monthly, etc., or based on durations (e.g., time since last use of a secret, time since last rotation of a secret, time since creation of a secret, secret expiration time, etc.). Examples of triggering events to begin process 400 may include requests (e.g., requests by user 131 or computer 130 to access a resource on network 110, such a databases 140 or server 150, or the like). Further triggering events may be determinations that user 131 or computer 130 will need future access to a resource on network 110, startup of an application being run by user 131, computer 130, or a resource on network 110, determination that user 131 or computer 130 has engaged in suspicious behavior (e.g., based on behavioral or historical analysis), etc. Further, process 400 may commence based on a security policy for an organization defining, for example, when secret rotation should occur, how long secrets should last before expiring, which users are entitled to access secrets, etc. Additionally, in some embodiments process 400 may commence based on commencement of (e.g., before or after) process 500, as discussed above.

At step 405 of process 400, secret rotation manager 160 operating in first network environment 305 may identify an encrypted version of a first key material. Key material may comprise information, such as a string of letters or numbers, which may be processed through a cryptographic algorithm to encode and decode data. For example, key material may identify cryptographic secrets that compose a key. The unencrypted version of the first key material may be used by rotation agent 120 to generate a secret for access to a target service 315 within second network environment 310. However, the key material may be encrypted such that secret rotation manager 160 operating in first network environment 305 may not have access to the clear key material, which increases security in storage of the key material in the first network environment 305. The key material may be encrypted using a public key of the rotation agent 120 such that secret rotation manager 160 may not be able to decrypt the encrypted first key material, but rotation agent 120 may decrypt the key material using the private key of the rotation agent 120, as disclosed herein.

In some embodiments, process 400 may follow step 405A, wherein identifying an encrypted version of a first key material may comprise receiving the encrypted first key material from a customer operating in the second network environment 310. For example, a customer, such as user 131, or an application or component operating in second network environment 310, may generate and encrypt the first key material. The first key material may be generated using any known methods for generating key material. For example, the first key material may be generated using a hardware security module, a random bit generator, or any other methods suitable for generating a first key material. The first key material may then be encrypted using a public key of the rotation agent 120, as described below. The secret rotation manager 160 operating in the first network environment 305 may then receive the encrypted first key material from the customer operating in the second network environment 310.

In other embodiments, process 400 may follow step 405B, wherein identifying the encrypted version of the first key material may comprise generating the first key material, encrypting the first key material, and storing the encrypted first key material. The first key material may be generated within the first network environment 305 through use of a random or pseudo-random generator. For example, secret rotation manager 160 may generate the first key material through a random or pseudo-random generator and encrypt the first key material using a public key of the rotation agent 120. The secret rotation manager 160 may then store only the encrypted version of the first key material and delete the unencrypted version of the first key material. For example, secret rotation manager 160 may store the encrypted version of the first key material in secret store 320. Thereafter, the secret rotation manager 160 may only have access to an encrypted version of the first key material without the ability to decrypt the first key material. In other embodiments, other components within first network environment 305 may generate the first key material and encrypt the first key material according to the public key of the rotation agent 120. Secret rotation manager 160 may then receive the encrypted first key material from the other component within the first network environment 305 and store the encrypted first key material in secret store 320 without the ability to decrypt the first key material.

At step 410 of process 400, secret rotation manager 160 may generate an additional key material. In some embodiments, the additional key material may be the same as the first key material. In other embodiments, the additional key material may differ from the first key material. Generating the additional key material may comprise generating a random value. In some embodiments, the additional key material may be a random value that represents a delta from the encrypted first key material. In some embodiments, a component within first network environment 305 may generate the random value through use of a random generator. In other embodiments, a third party high-grade random generator may generate the random value. For example, a true Random Number Generator may be used to generate the random value. A true Random Number Generator may comprise a physical process capable of producing entropy, a hardware security module (HSM), or a cloud HSM such as AWS CloudHSM™. Use of a high-grade random generator may provide increased security by providing a truly random value from the first key material.

At step 415 of process 400, secret rotation manager 160 may determine whether the additional key material is to be encrypted, or whether additional key material will remain unencrypted. Encrypting the additional key material may provide additional security in the transmission of the additional key material from the secret rotation manager 160 to the rotation agent 120. For example, it may be determined at step 415 that the additional key material is to be encrypted based on customer or network environment security requirements or a secret generation policy. In some embodiments, the additional key material may not be encrypted during process 400. In such an embodiment, process 400 may follow step 415A from step 415 directly to step 420 of process 400.

In other embodiments, it may be determined at step 415 that the additional key material is to be encrypted. In such an embodiment, process 400 will follow step 415B of process 400 to encrypt the additional key material. At step 415B of process 400, the additional key material generated by the secret rotation manager 160 may be encrypted by the secret rotation manager 160 using the public key of the rotation agent 120. For example, secret rotation manager 160 may possess the public key of the rotation agent 120, as disclosed herein, and may use the public key of the rotation agent 120 to encrypt the additional key material. Encrypting the additional key material using the public key of the rotation agent 120 may provide increased security when providing the first encrypted key material and the encrypted additional key material from secret rotation manager 160 to rotation agent 120. For example, encrypting the additional key material in addition to the first key material provides increased protection from an attacker accessing a clear version of the additional key material.

At step 420 of process 400, secret rotation manager 160 may combine the encrypted first key material and the encrypted or unencrypted additional key material. In some embodiments, process 400 may follow step 420A, wherein combining the encrypted first key material and the encrypted or unencrypted additional key material may comprise a concatenation. For example, combining the encrypted first key material and the encrypted or unencrypted additional key material may comprise merging or joining the strings of the encrypted first key material and the encrypted or unencrypted additional key material into one string. Combining the first encrypted key material and the encrypted or unencrypted additional key material may allow the combined key materials to be provided by secret rotation manager 160 to rotation agent 120 in one string of data.

In other embodiments, process 400 may follow step 420B, wherein combining the encrypted first key material and the encrypted or unencrypted additional key material may alternatively comprise a homomorphic encryption scheme. For example, in some embodiments, the homomorphic encryption schemes may comprise an RSA public key encryption scheme, a Paillier cryptosystem, the Brakerski-Gentry-Vaikuntanathan (BGV) fully homomorphic encryption (FHE), or any other encryption scheme suitable for combining the first key material and the encrypted or unencrypted additional key material. Homomorphic encryption may allow secret rotation manager 160 to perform a combination of the encrypted first key material with the encrypted or unencrypted additional key material without decrypting or having knowledge of the encrypted first key material. For example, by using homomorphic encryption, secret rotation manager 160 may perform a computation on encrypted first key material and the encrypted or unencrypted additional key material with a resulting output remaining in an encrypted form. Such computation may be performed despite the secret rotation manager 160 being blind to the unencrypted version of the first key material.

In some embodiments, combining the encrypted first key material with the encrypted or unencrypted additional key material through either step 420A or 420B of process 400 may further compact the key materials before sending the key materials from the secret rotation manager 160 to the rotation agent 120. As secrets are rotated over time, new key materials may be generated based on the first key material and prior key materials. In some embodiments, the combined key material may comprise a chain of values between the encrypted first key material and a plurality of additional key materials. Because the chain of values between the encrypted first key material and the plurality of additional key materials may grow over time as secrets are rotated, combining the encrypted first key material and the encrypted or unencrypted additional key material through concatenation (step 420A) or homomorphic encryption (step 420B) may compact the key materials before sending the combined key materials from the secret rotation manager 160 to the rotation agent 120. In some embodiments, combining the key materials may comprise modular multiplication. Combining and compacting the key materials may reduce the data elements, bandwidth, and time associated with sending the combined key material from secret rotation manager 160 to the rotation agent 120.

In such an embodiment, each new key material may comprise a random value from the prior key material. The chain of values between the encrypted first key material and the plurality of additional key materials may be stored in a secret store, such as secret store 320, within the first network environment 305. In some embodiments, the plurality of additional key materials may be retrieved from the secret store 320 by the secret rotation manager 160. The secret rotation manager 160 may then combine the encrypted first key material with the plurality of additional key materials and the newly generated additional key material.

In some embodiments, process 400 may skip steps 420, 420A, and 420B. In such embodiments, the encrypted first key material and the additional key material may not be combined or compacted. The encrypted first key material and the additional key material may be provided to the rotation agent as a stack of uncombined values.

At step 430 of process 400, the secret rotation manager 160 may provide the combined key material to the rotation agent 120 operating in the second network environment 310. Providing the combined key material to the rotation agent 120 operating in the second network environment 310 may comprise sending the combined key material via an Internet or other network connection between secret rotation manager 160 and rotation agent 120. For example, secret rotation manager 160 may provide the combined key material to rotation agent 120 via the Internet or a private network connection using a web portal, website, or other application.

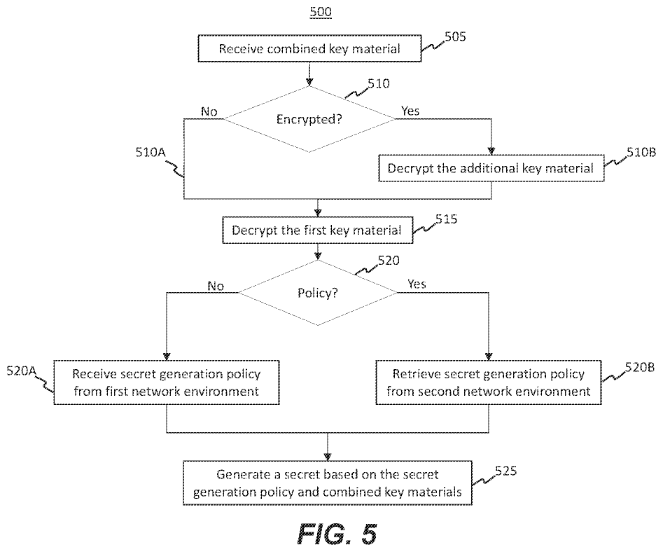

FIG. 5 is a flowchart depicting process 500 for providing blind secret management and rotation by a rotation agent 120, consistent with the disclosed embodiments. Similar to process 400 as described above, process 500 may commence continuously, periodically, upon a trigger event, or manually. The same examples as described above in connection with process 400 may pertain to process 500 too. Likewise, process 500 may commence based on a security policy for an organization defining, for example, when secret rotation should occur, how long secrets should last before expiring, which users are entitled to access secrets, etc. Additionally, in some embodiments process 500 may commence based on commencement of (e.g., before or after) process 400, as discussed above.

At step 505 of process 500, rotation agent 120 may receive the combined key materials from secret rotation manager 160. The rotation agent 120 may receive the combined key materials via an Internet or other network connection between secret rotation manager 160 and rotation agent 120. For example, rotation agent 120 may receive the combined key material provided by secret rotation manager 160 in step 430 of process 400, with respect to FIG. 4.

At step 510 of process 500, rotation agent 120 may determine if the additional key material provided by secret rotation manager 160 is encrypted or unencrypted. As disclosed herein with respect to step 415 of process 400, the additional key material may be encrypted or unencrypted based on customer or network environment security requirements or a secret generation policy. In some embodiments, if the additional key material received by rotation agent 120 is not encrypted, then process 500 may follow step 510A directly from step 510 to step 515.

In other embodiments, if the additional key material received by rotation agent 120 is encrypted, then process 500 may follow from step 510 to step 510B. As discussed above with respect to step 415B of process 400, the secret rotation manager 160 may encrypt the additional key material using the public key of the rotation agent 120. At step 510B of process 500, rotation agent 120 may decrypt the additional key material using the private key of the rotation agent 120. The public key used by secret rotation manager 160 to encrypt the additional key material and the private key used by the rotation agent 120 to decrypt the additional key material may be a private and public key pair used as part of an asymmetric encryption scheme between the rotation agent 120 and the secret rotation manager 160. Accordingly, at step 510B of process 500, rotation agent 120 may use its private key to decrypt the additional key material.

At step 515 of process 500, the rotation agent 120 may decrypt the encrypted first key material from the combined key material. As discussed above with respect to step 405, the encrypted first key material may be encrypted with the public key of the rotation agent 120. The rotation agent 120 may use the private key associated with the public key to decrypt the combined key material. For example, because the encrypted first key material is encrypted with the public key of the rotation agent 120, secret rotation manager 160 may not be able to decrypt and access the encrypted first key material because the secret rotation manager 160 does not have the private key of the rotation agent 120. However, after secret rotation manager 160 provides the combined key material to rotation agent 120, the rotation agent 120 may use its private key to decrypt the encrypted first key material.

At step 520 of process 500, rotation agent 120 may determine if a secret generation policy is stored within first network environment 305 or second network environment 310. A secret generation policy may comprise a set of rules for secrets used within second network environment 310 for accessing a target service, such as target service 315. For example, the secret generation policy may require the generated secret to be a certain number of characters, include lowercase or uppercase letters, numbers, or special characters, or any other set of rules regarding the generation of a secret for accessing a target service, such as target service 315.

In some embodiments, the secret generation policy may be stored in the first network environment 305 and process 500 may follow step 520A. At step 520A of process 500, rotation agent 120 may receive the secret generation policy from the secret rotation manager 160 in the first network environment 305. For example, the secret generation policy may be stored within a first secure location in the first network environment 305, such as a policy store. The first secure location in the first network environment 305 may be configured to store, manage, and provide the secret generation policy to the secret rotation manager 160. Secret rotation manager 160 may retrieve the secret generation policy from the first secure location in first network environment 305, such as the policy store, and provide the secret generation policy with the combined key material to rotation agent 120.

In other embodiments, the secret generation policy may be stored in the second network environment 310 and process 500 may follow step 520B. At step 520B of process 500, rotation agent 120 may retrieve the secret generation policy from the second network environment 310. For example, the secret generation policy may be stored in a second secure location accessible to the rotation agent 120 in the second network environment 310. The rotation agent 120 may retrieve the secret generation policy from the second secure location in the second network environment 310 after receiving the combined key material from the secret rotation manager 160. In other embodiments, the secret generation policy may be provided to the rotation agent 120 by a third-party. For example, the secret generation policy may be managed by a third-party component, such as a policy manager, in the first network environment 305 or the second network environment 310. The third-party component, such as a policy manager, may be configured to store, manage, and provide the secret generation policy to the rotation agent 120.

At step 525 of process 500, the rotation agent 120 may generate, according to the secret generation policy, a secret using at least the combined key material. The secret may be generated by rotation agent 120 by using a deterministic algorithm based on the secret generation policy. A deterministic algorithm may comprise an algorithm that will produce the same output given a specific input. For example, the deterministic algorithm may compute an output based solely on the received input without any randomness. Rotation agent 120 may use the combined key material and the secret generation policy as input in a deterministic algorithm to generate the new secret for accessing a target service, such as target service 315. For example, the rotation agent 120 may generate the secret using a deterministic algorithm based on the decrypted first key material, the additional key material, and the secret generation policy. The secret generated by rotation agent 120 may comprise passwords, usernames, credentials, Application Programming Interface (API) keys, encryption keys, hash values, identity and access management (IAM) permissions, SSH keys, tokens, certificates, biometric data, or any other form of access credential for use in managing access to applications, services, privileged accounts, and other secure network resources.

In some embodiments, process 500 may further comprise storing the decrypted first key material and the secret in a non-persistent and secured memory region in the second network environment 310. A non-persistent and secured memory may be a memory which is available only during execution of an application. For example, the non-persistent and secured memory may be accessible by rotation agent 120 while the processes of rotation agent 120 or target service 315 are being executed. The non-persistent and secured memory region may be accessible only to rotation agent 120, or other necessary components of second network environment 310, and may be secured from access by other components within first network environment 305 or second network environment 310. The decrypted first key material and the secret may be stored in a non-persistent and secured memory region of second network environment 310 such that the decrypted first key material and the secret may be removed after the session with target service 315 or rotation agent 120 has expired. Storing the decrypted first key material and the secret in a non-persistent and secured memory region may allow the secret to be used to access target service 315, but the decrypted first key material and the clear secret may be removed after the session with target service 315 has expired to ensure that the decrypted first key material and the clear secret remain secure and are not accessed by outside components or attackers.

In other embodiments, process 500 may further comprise storing the decrypted first key material and the secret exclusively in volatile memory of the second network environment. Volatile memory may provide temporary storage of the decrypted first key material and the secret. Volatile memory may comprise random access memory (RAM), dynamic random access memory (DRAM), cache memory, processor registers, or any other form of volatile memory. In other embodiments, the decrypted first key material and the secret may be stored in non-volatile memory (such as a hard disk) or persistent memory (PMEM). In other embodiments, the decrypted first key material and the secret may be stored in a protected memory region of the second network environment. Protected memory may comprise a hardware enabled protection of the memory, such as a secure enclave. The protected memory may provide a CPU hardware-level isolation and memory encryption by isolating the decrypted first key material and the secret. The protected memory may comprise Intel® SGX, Arm® TrustZone®, or any other form of protected memory.

In some embodiments, process 500 may further comprise storing the decrypted first key material and the secret in cleartext configured for registration of the secret with a target service, such as target service 315, in the second network environment 310. Registering the secret with a target service, such as target service 315 may comprise entering the secret with target service 315 to allow a user, such as user 131, to access target service 315 using the newly generated secret. Storing the decrypted first key material and the secret in cleartext may comprise storing the decrypted first key material and the secret in an unencrypted form that is consumable and readable. In such an embodiment, the decrypted first key material and the secret may be stored in cleartext in the second network environment 310 only for enough time to register the secret with a target service, such as target service 315. For example, the decrypted first key material and the secret may be deleted as soon as the newly generated secret has been registered with the target service 315. This increases security within system 300, because the decrypted first key material and the secret are not stored in a persistent memory or stored for a long period of time. For example, storing such information in clear text for a long period of time may provide an opportunity for an attacker to access the unencrypted information and access secure services in second network environment 310. Therefore, the decrypted first key material and secret may be stored in cleartext for only enough time to register the secret with a target service, such as target service 315 and then may be deleted after the secret has been registered with target service 315.

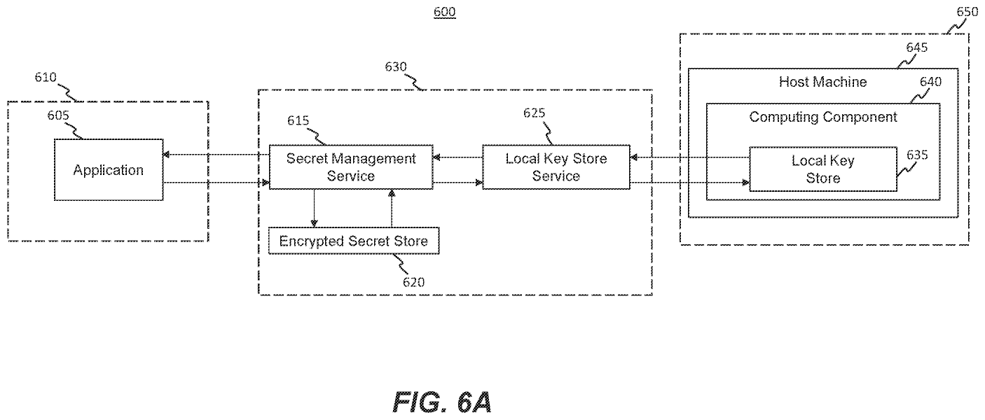

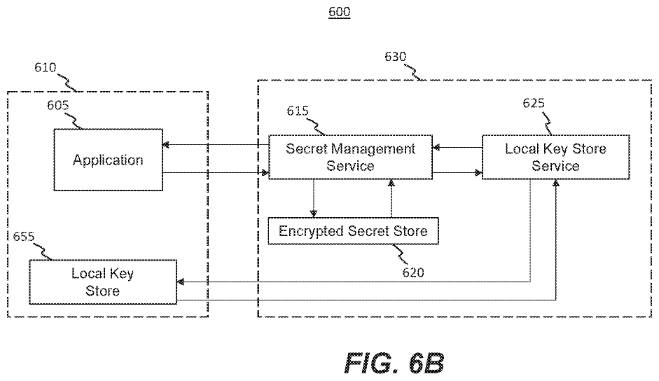

In some embodiments, rotation agent 120 may be further configured to generate a public key and a private key and to store the public key and the private key. In such an embodiment, process 400 may further comprise receiving, by the secret rotation manager 160, the public key and wherein encrypting the additional key material may comprise using the public key and decrypting the additional key material may comprise using the private key. Rotation agent 120 may generate the public and private key pair using any known methods for generating a public and private key pair. For example, the public and private key pair may be generated using an asymmetric algorithm that pairs an associated public key and private key, such as the Rivest-Shamir-Adleman algorithm, elliptic curve cryptography, digital signature algorithm, or any other algorithm suitable for generating a public and private key pair. In some embodiments, rotation agent 120 may store the public key and the private key in the second network environment 310 for later use in decrypting key material received from the secret rotation manager 160. In other embodiments, rotation agent 120 may store the private key in a local key store, such as local key store 635, as disclosed herein with respect to FIG. 6A. In such an embodiment, the private key may comprise the cryptographic master key of FIGS. 6A and 6B. Rotation agent 120 may access the local key store to retrieve the public key and the private key. The secret rotation manager 160 may receive the public key generated by the rotation agent 120. The secret rotation manager 160 may only have access to the public key, while not having access to the private key generated by the rotation agent 120. The secret rotation manager 160 may use the public key to encrypt the additional key material generated by secret rotation manager 160 at step 415B of process 400. Secret rotation manager 160 may encrypt the additional key material using the public key of the rotation agent 120 using any known methods for encrypting data using a public key. After secret rotation manager 160 provides the combined encrypted key material to rotation agent 120, rotation agent 120 may use the stored private key to decrypt the combined encrypted key material.

FIG. 6A is a block diagram showing a process 600 for providing a clear secret corresponding to an encrypted secret in accordance with disclosed embodiments. In some embodiments, process 600 may be used, for example, when a network identity, such as user 131, wants or needs to view a clear secret to connect with a target resource. In such embodiments, the secret may remain encrypted when within the first network environment and may be decrypted only within the second network environment. Such a process may allow the secret to be transmitted to the network identity in the second network environment while the first network environment may remain blind to the secret. In some embodiments, process 600 may be used in combination with processes 400 and/or 500, as disclosed herein with respect to FIG. 4 and FIG. 5, respectively.

As depicted in FIG. 6A, a network identity operating application 605 may access a secret management service 615 to request a clear secret to access a target resource. Application 605 may comprise a browser, a network resource, a program, or any target resource that may be accessed by a network identity. Application 605 may operate in second network environment 610. Second network environment 610 may correspond to second network environment 310, as disclosed herein with respect to FIG. 3. For example, second network environment 610 may comprise an on-premises computing environment or a cloud computing environment. The network identity, such as user 131, may access the secret management service 615 from a computing device, such as computing device 130.

Secret management service 615 may comprise a password vault. For example, secret management service 615 may be any form of secure storage location for storing encrypted secrets, which may include, but are not limited to passwords, usernames, credentials, Application Programming Interface (API) keys, encryption keys, hash values, identity and access management (IAM) permissions, Secure Shell Protocol (SSH) keys, tokens, certificates, biometric data, or any other form of access credential for use in managing access to applications, services, privileged accounts, and other secure network resources. Secret management service 615 may allow for central management of encrypted secrets across multiple accounts within a network and allow security access policies to be consistently enforced across multiple accounts. Secret management service 615 may only store encrypted secrets and may not have the ability to decrypt the encrypted secrets.

Secret management service 615 may operate in a first network environment 630. First network environment 630 may correspond to first network environment 305, as disclosed herein with respect to FIG. 3. For example, first network environment 305 may comprise an on-premises computing environment or a cloud computing environment, such as a Software as a Service (SaaS) system, a Platform as a Service (PaaS), or Infrastructure as a Service (IaaS) system. The network identity, such as user 131, may have access to both the first network environment 630 and second network environment 610. However, a system operator of the first network environment 630 may not have access to the second network environment 610.

The request from the network identity operating application 605 to secret management service 615 may comprise a request to provide a clear secret managed by secret management service 615. In some embodiments, the secrets managed by secret management service 615 may be associated with network accounts. A network account may comprise a directory account having a username and password that may enable the network identity to access a computing resource or to join a particular domain. In other embodiments, secret management service 615 may manage standalone secrets that may not be associated with a username and password pair. For example, secret management service 615 may manage secrets such as a credit card number, personal identifiable information, or other standalone secrets. The request may comprise a secret identifier and a public key of a key pair.

A secret identifier may comprise any kind of identification of a particular secret as managed by secret management service 615. For example, a secret identifier may comprise a string of characters, a name, a string of numbers, or any other form of identification that may be associated with the secret. In some embodiments, secrets associated with the accounts managed by secret management service 615 may be stored in secure, hierarchical storage. The secret identifier may reference the particular secret associated with the account that the network identity seeks to access and may allow secret management service 615 to identify and provide the encrypted secret. In some embodiments, the secret identifier may be received from secret management service 615 following a request from a network identity, such as user 131, to provide a list of accounts and secrets. In other embodiments, the secret identifier may be provided by the network identity, such as user 131, in the request to secret management service 605.

The public key may comprise a key associated with a key pair. In some embodiments, application 605 may generate a cryptographic key pair, including a public key and a private key, for use in process 600. Application 605 may generate the public and private key pair using any known methods for generating a public and private key pair. For example, the public and private key pair may be generated using an asymmetric algorithm that pairs an associated public key and private key, such as the Rivest-Shamir-Adleman algorithm, elliptic curve cryptography, digital signature algorithm, or any other algorithm suitable for generating a public and private key pair. Application 605 may store the private key in second network environment 610 for later use in decrypting the secret received from the secret management service 615. The public key may be provided to the secret management service 615 as part of the request for the secret. The secret management service 615 operating in first network environment 630 may only have access to the public key while not having access to the private key generated by application 605.

Secret management service 615 may retrieve the secret from a secure location, such as encrypted secret store 620, within the first network environment 630. Secret management service 615 may retrieve the secret based on the corresponding secret identifier provided in the request from application 605. Encrypted secret store 620 may correspond to secret store 320 as disclosed herein with respect to FIG. 3. For example, encrypted secret store 620 may comprise a secure storage location for storing secrets. Encrypted secret store 620 may authenticate and authorize users, identities, machines, or applications attempting to access one or more secrets before permitting access to stored sensitive data.

Secret management service 615 may then send the retrieved secret and the public key through local key store service 625 to a local key store 635. Local key store service 625 may create, maintain, and administer key stores, such as local key store 635. Local key store 635 may be located in the client environment 650. In some embodiments, client environment 650 may comprise a self-hosted server. In other embodiments, client environment 650 may comprise a virtual machine in a cloud environment operated by a client. In other embodiments, client environment 650 may comprise a computing device associated with the network identity. In some embodiments, the client environment 650 may correspond to second environment 610. In some embodiments, as depicted in FIG. 6A, local key store 635 may be accessed by a computing component 640 through a host machine 645 within client environment 650. The host machine 645 may comprise a target machine that may be accessed to receive a secret through local key store 635. In other embodiments, the local key store 635 may be a standalone component within the client environment 650. In other embodiments, as depicted in FIG. 6B, a local key store 655 may be located in a computing device, such as computing device 130, within second network environment 610. Local key store 655, may correspond to local key store 635, as disclosed herein with respect to FIG. 6A.

Local key store 635 may decrypt the encrypted secret received from the secret management service 615 through local key store service 625. Local key store 635 may comprise a repository containing cryptographic materials, such as certificates, private keys, or master keys. The local key store 635 may decrypt the encrypted secret by using a cryptographic master key. A cryptographic master key may be a key that may protect other keys, such as the encrypted secret, when those keys are in storage, use, or transit. In some embodiments, the cryptographic master key may be the private key of a key pair generated by rotation agent 120. The cryptographic master key may be used to decrypt a plurality of secrets, including secrets managed by secret management service 615.

The local key store 635 may then re-encrypt the unencrypted secret using the public key provided in the request from application 605. The local key store may return the encrypted secret that has been encrypted with the public key of application 605 to the secret management service 615 through local key store service 625. Secret management service 615 may then return the encrypted secret to application 605. Application 605 may decrypt the secret using the private key generated by application 605. Application 605 may then provide the clear password to the network identity. Providing the clear secret to the network identity may comprise presenting the clear secret to the network identity through the application, using the clear secret for a secure shell (SSH) remote access to a target resource, injecting the clear secret to a third-party application, or any other form of providing the clear secret to the network identity for use by the network identity to access a target resource.

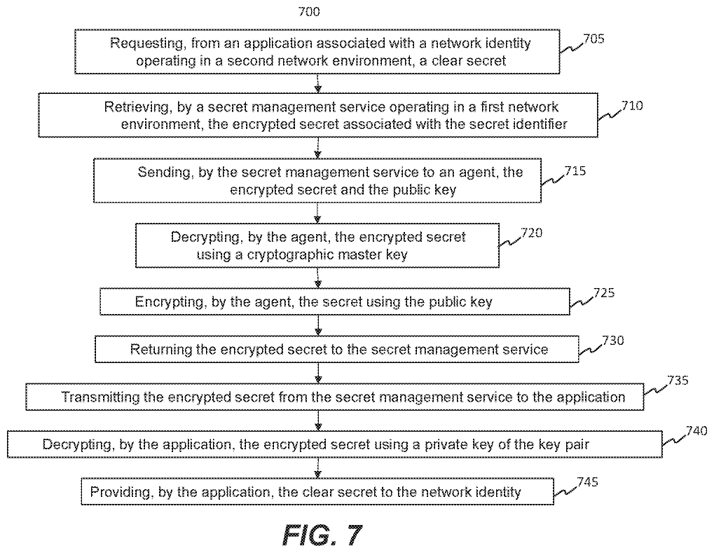

FIG. 7 depicts a flowchart showing a process 700 for providing a clear secret corresponding to an encrypted secret in accordance with disclosed embodiments. Similar to processes 400 and 500 as described above, process 700 may commence continuously, periodically, upon a trigger event, or manually. The same examples as described above in connection with processes 400 and 500 may pertain to process 700. Likewise, process 700 may commence based on a security policy for an organization defining, for example, when secret rotation should occur, how long secrets should last before expiring, which users are entitled to access secrets, etc. Additionally, in some embodiments process 700 may commence based on commencement of (e.g., before or after) processes 400 and 500, as discussed above.

Step 705 of process 700 may comprise requesting, from an application associated with a network identity operating in a second network environment, the clear secret, wherein the request may comprise a secret identifier and a public key of a key pair. The application associated with a network identity may correspond to application 605, as disclosed herein with respect to FIG. 6A. The application may be operating in a second network environment, which may correspond to second network environment 610 as disclosed herein with respect to FIG. 6A. The network identity may request a clear secret associated with an account. In some embodiments, requesting the clear secret may comprise invoking an application programming interface (API) of a secret management service with the request.

An account may comprise a directory account having a username and password that may enable the network identity to access a computing resource to join a particular domain. For example, the clear secret requested by the application may be associated with an account. The request may comprise a secret identifier and a public key of a key pair. A secret identifier may comprise an identification of a particular secret associated with an account, as disclosed herein with respect to FIG. 6A. The public key may comprise a key associated with a key pair. In some embodiments, the application may generate a cryptographic key pair, including a public key and a private key, for use in process 700. The application may store the private key in a location that may be accessible to the application. For example, the application may store the private key in a secure location in the second network environment for later use in decrypting the secret. The public key may be provided as part of the request for the secret.

Step 710 of process 700 may comprise retrieving, by a secret management service operating in a first network environment, the encrypted secret associated with secret identifier. The secret management service may correspond to secret management service 615 as disclosed herein with respect to FIG. 6A. For example, the secret management service may manage a plurality of accounts and may allow for central management of encrypted secrets across the plurality of accounts within a network and allow security access policies to be consistently enforced across the plurality of accounts. The secret management service may operate in a first network environment, which may correspond to first network environment 630, as disclosed herein with respect to FIG. 6A. Secret management service may retrieve the secret based on the corresponding secret identifier provided in the request from the application.

Step 715 of process 700 may comprise sending, by the secret management service to an agent, the encrypted secret and the public key. In some embodiments, the agent may correspond to local key store 635, as disclosed herein with respect to FIG. 6A. In other embodiments, the agent may correspond to the rotation agent 120 as disclosed herein with respect to FIG. 1. In other embodiments, the agent may comprise any cryptographic element that may encrypt, decrypt, and manage secrets. The secret management service may send both the retrieved encrypted secret and the public key provided in the request from the application to the agent for decryption. In some embodiments, as depicted in FIG. 6B, the agent may be located on a computing device associated with the network identity. In other embodiments, the agent may be located in an on-premises server in the second network environment. In other embodiments, the agent may be located in a cloud-based environment in the second network environment.

Step 720 of process 700 may comprise decrypting, by the agent the encrypted secret using a cryptographic master key. The cryptographic master key may be a key that may protect other keys, such as the encrypted secret, when those keys are in storage, use, or transit. The cryptographic master key may be used to decrypt a plurality of keys, including secrets managed by the secret management service. The agent may use the cryptographic master key to decrypt the secret received from the secret management service.

Step 725 of process 700 may include encrypting, by the agent, the secret using the public key. The agent may re-encrypt the decrypted secret so that the secret is not transferred through the secret management service in the clear. The agent may use the public key generated by the application and transferred through the secret management service to re-encrypt the secret. Re-encrypting the decrypted secret may allow the agent to return the secret to the application through the secret management service without allowing the secret management service to view the clear secret. The secret management service may not have the private key associated with the public key used to re-encrypt the secret and therefore the secret management service may remain blind to the secret.

Step 730 of process 700 may include returning the encrypted secret to the secret management service. The secret, encrypted by the agent using the public key of the application, may be returned to the secret management service and the secret management service may not be able to decrypt the encrypted secret. The secret management service operating in the first network environment may, therefore, remain blind to the secret throughout process 700. Step 735 of process 700 may include transmitting the encrypted secret from the secret management service to the application. The secret management service may provide the encrypted secret back to the application in response to the request from the application for the clear secret.

Step 740 of process 700 may include decrypting, by the application, the encrypted secret using a private key of the key pair, and step 745 of process 700 may include providing, by the application, the clear secret to the network identity. The application may decrypt the encrypted secret using the private key generated by the application. The private key may correspond to the public key used by the local key store to encrypt the secret, which may allow the application to decrypt the encrypted secret. The application may then provide the clear secret to the network identity in response to the request by the network identity. For example, providing the clear secret to the network identity may comprise presenting the clear secret to the network identity through the application, using the clear secret for a secure shell (SSH) remote access to a target resource, injecting the clear secret to a third-party application, or any other form of providing the clear secret to the network identity for use by the network identity to access a target resource.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials, and code types will be developed, and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments unless the embodiment is inoperative without those elements.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A non-transitory computer readable medium including instructions that, when executed by at least one processor, cause the at least one processor to perform operations for providing blind secret management and rotation, the operations comprising:
identifying, by a secret rotation manager operating in a first network environment, an encrypted version of a first key material;
generating, by the secret rotation manager, an additional key material; and
providing the first key material and the additional key material to at least one rotation agent operating in a second network environment;
wherein the at least one rotation agent is configured to decrypt at least the encrypted first key material; and
wherein the at least one rotation agent is configured to generate, according to a secret generation policy, a secret using at least the first key material and the additional key material.

2. The non-transitory computer readable medium of claim 1, wherein the operations further comprise:
encrypting, by the secret rotation manager, the additional key material;
combining the encrypted first key material and the encrypted additional key material; and
providing the combined encrypted key material to the at least one rotation agent;
wherein the at least one rotation agent is configured to decrypt the combined encrypted key material.

3. The non-transitory computer readable medium of claim 2, wherein combining the encrypted first key material and the encrypted additional key material is based on at least one of:
concatenation or homomorphic encryption.

4. The non-transitory computer readable medium of claim 2, wherein the at least one rotation agent is further configured to generate a public key and a private key, and to access the public key and the private key; and
wherein the operations further comprise receiving, by the secret rotation manager, the public key; and
wherein encrypting the additional key material comprises using the public key and decrypting the additional key material comprises using the private key.

5. The non-transitory computer readable medium of claim 4, wherein the private key is stored in a local key store; and
wherein the operations further comprise accessing, by the at least one rotation agent, the private key from the local key store.

6. The non-transitory computer readable medium of claim 1, wherein identifying the encrypted version of the first key material comprises receiving, from a customer operating in the second network environment, the encrypted first key material.

7. The non-transitory computer readable medium of claim 1, wherein identifying the encrypted version of the first key material comprises:
generating the first key material;
encrypting the first key material; and
storing the encrypted first key material.

8. The non-transitory computer readable medium of claim 1, wherein generating the additional key material comprises generating a random value by at least one of: a random generator in the first network environment, the rotation agent or a third-party random generator.

9. The non-transitory computer readable medium of claim 1, wherein the decrypted first key material and the secret are stored in at least one of: a volatile memory or a protected memory region.

10. The non-transitory computer readable medium of claim 1, wherein the operations further comprise storing the decrypted first key material and the secret as cleartext configured for registration of the secret with a target service in the second network environment.

11. The non-transitory computer readable medium of claim 1, wherein the secret generation policy is provided to the at least one rotation agent by at least one of: the secret rotation manager, a storage location in the second network environment, or a third-party.

12. The non-transitory computer readable medium of claim 1, wherein the operations further comprise retrieving the secret generation policy from a first secure location in the first network environment or from a second secure location in the second network environment that is accessible to the at least one rotation agent.

13. The non-transitory computer readable medium of claim 1, wherein the combined key material is composed of a chain of values between the encrypted first key material and a plurality of additional key materials.

14. The non-transitory computer readable medium of claim 13, wherein the operations further comprise retrieving the plurality of additional key materials from a secret store.

15. The non-transitory computer readable medium of claim 13, wherein the operations further comprise compacting the encrypted first key material and the plurality of additional key materials.

16. A computer-implemented method for providing blind secret management and rotation, the operations comprising:
identifying, by a secret rotation manager operating in a first network environment, an encrypted version of a first key material;
generating, by the secret rotation manager, an additional key material; and
providing the first key material and the additional key material to at least one rotation agent operating in a second network environment;
wherein the at least one rotation agent is configured to decrypt at least the encrypted first key material; and
wherein the at least one rotation agent is configured to generate, according to a secret generation policy, a secret using at least the first key material and the additional key material.

17. The computer-implemented method of claim 16, wherein combining the encrypted first key material and the additional key material is based on at least one of: concatenation or homomorphic encryption.

18. The computer-implemented method of claim 17, wherein the homomorphic encryption comprises an RSA public key encryption scheme or an ElGamal encryption scheme.

19. The computer-implemented method of claim 16, wherein generating the additional key material comprises using a true Random Number Generator.

20. The computer implemented method of claim 16, wherein the operations further comprise:
encrypting the additional key material using a public key;
combining the encrypted first key material and the encrypted second key material; and
providing the combined encrypted key material to the at least one rotation agent; and
wherein the at least one rotation agent is configured to decrypt the combined encrypted key material using a private key of the at least one rotation agent.

21. A non-transitory computer readable medium including instructions that, when executed by at least one processor, cause the at least one processor to perform operations for providing a clear secret corresponding to an encrypted secret, the operations comprising:
requesting, from an application associated with a network identity operating in a second network environment, the clear secret, wherein the request comprises a secret identifier and a public key of a key pair;
retrieving, by a secret management service operating in a first network environment, the encrypted secret associated with the secret identifier;
sending, by the secret management service to an agent, the encrypted secret and the public key;
decrypting, by the agent, the encrypted secret using a cryptographic master key;
encrypting, by the agent, the secret using the public key;
returning the encrypted secret to the secret management service;
transmitting the encrypted secret from the secret management service to the application;
decrypting, by the application, the encrypted secret using a private key of the key pair; and
providing, by the application, the clear secret to the network identity.

22. The non-transitory computer readable medium of claim 21, wherein the operations further comprise generating, by the application, the key pair.

23. The non-transitory computer readable medium of claim 21, wherein the operations further comprise storing the private key in a location accessible by the application.

24. The non-transitory computer readable medium of claim 21, wherein the agent is at least on of: the rotation agent or a local key store.

25. The non-transitory computer readable medium of claim 21, wherein the agent is located in one of: a computing device associated with the network identity, an on-premises computing device operating in the second network environment, or a cloud-based environment.

26. The non-transitory computer readable medium of claim 21, wherein the first network environment comprises a cloud-based environment.

27. The non-transitory computer readable medium of claim 21, wherein the secret management service is blind to the clear secret.

28. The non-transitory computer readable medium of claim 21, wherein the clear secret is associated with an account.

29. The non-transitory computer readable medium of claim 28, wherein the account comprises a directory account enabling the network identity to access a computing resource.

30. The non-transitory computer readable medium of claim 21, wherein the second network environment comprises at least one of: a cloud-based environment or a self-hosted server.
